(19) United States
(12) Patent Application Publication
(10) Pub. No.: US 2017/0185577 A1
(43) Pub. Date: Jun. 29, 2017

(54) METHOD AND DEVICE FOR EXTENDING A LAYOUT TEMPLATE OF AN APPLICATION COMPONENT

(71) Applicant: Alibaba Group Holding Limited, George Town (KY)

(72) Inventors: Shuting CHEN, Hangzhou (CN); Min CHANG, Hangzhou (CN); Lei MA, Hangzhou (CN)

(21) Appl. No.: 15/383,316

(22) Filed: Dec. 19, 2016

(30) Foreign Application Priority Data
Dec. 25, 2015 (CN) 201510997256.9

(51) Int. Cl. G06F 17/24; G06F 17/21

(52) U.S. Cl. CPC G06F 17/248; G06F 17/212

(57) ABSTRACT

The present application provides a method and a device for extending a layout template of a component. The method includes determining an inheritance relationship between a component to be extended and an existing component, generating extension information of the component to be extended according to the inheritance relationship, where the extension information includes identification (ID) information of the existing component, the inheritance relationship, and content to be extended. The method further includes acquiring a layout template object of the existing component according to the ID information of the existing component, where the layout template object is configured with at least one element item of the corresponding component, and updating the element item in the layout template object according to the inheritance relationship and the content to be extended to obtain a layout template object. A layout template is extended using an inheritance relationship between objects to simplify the management of the layout templates and the complexity of maintenance and updates.

### CROSS-REFERENCE TO RELATED APPLICATION

This application claims priority to Chinese Patent Application No. 201510997256.9, filed on Dec. 25, 2015, which is incorporated herein by reference in its entirety.

### TECHNICAL FIELD

Embodiments of the present application relate to layout templates for applications, and more particularly, to a method and a device for extending a layout template of a component of an application.

### BACKGROUND

With the recent developments in mobile services, multiple services of different display types may need to be supported in one application of a mobile terminal device, and discrepancies in the layouts of the different services may cause a conflict in the configuration of the service templates. Additionally, for services of the same service type, there may be one or n service states. For example, the states of a service may include a first state when the service is started, and a second state when the service is not started. Moreover, display content corresponding to different service states may vary, and configurations of corresponding service templates may also be different. In addition, some components may be newly added each time a new version is released, and a new template is only applicable to the new application (“app”) version. Therefore, a new template may need to be configured for a service type that has been updated or has newly added features or attributes.

For example, if nine service types are online and each service type currently has two states, eighteen component-based layout templates are needed. After a new version is released, a component is newly added for each service type, and an additional eighteen component-based layout templates need to be added. Therefore, factors such as different services, different states of a product, and different component-based versions supported by a client all contribute to an explosive increase in the number of templates needed. Moreover, each component-based template has a certain degree of complexity. The costs for adding a new template and verifying the new template are both very high, and the maintenance and management of the templates becomes very difficult.

### SUMMARY

The present application intends to solve the foregoing technical problem to a particular extent.

For this reason, a first objective of the present application is to provide a method for extending a layout template of a component to simplify the management of a layout template and the complexity of maintenance and updates.

A second objective of the present application is to provide a device for extending a layout template of a component.

To achieve the foregoing objectives, according to one embodiment, a method for extending a layout template of a component is disclosed. The method includes determining an inheritance relationship between a component and an existing component, generating extension information for the component to be extended based on the inheritance relationship, where the extension information includes identification information of the existing component, the inheritance relationship, and content to be extended, acquiring a layout template object of the existing component based on the ID information of the existing component, where the layout template object uses at least one element item of the corresponding component, and updating the element item in the layout template object according to the inheritance relationship and the content to be extended to obtain a layout template object for the component.

According to another embodiment, a device for extending a layout template of a component is disclosed. The device includes a determining module, configured to determine an inheritance relationship between a component and an existing component, a generation module, configured to generate extension information of the component to be extended according to the inheritance relationship, where the extension information includes identification information of the existing component, the inheritance relationship, and content to be extended, an acquiring module, configured to acquire a layout template object of the existing component according to the identification information of the existing component, where the layout template object is configured with at least one element item of the corresponding component, and an update module, configured to update the element item in the layout template object according to the inheritance relationship and the content to be extended, so as to obtain a layout template object of the component.

Some additional aspects and advantages of the present application are partially provided in the description and some become obvious from the description below, or may be learned through the practices in the present application.

### BRIEF DESCRIPTION OF THE DRAWINGS

The foregoing and/or additional aspects and advantages of the present application become clear and more readily understandable from the description of the embodiments with reference to the accompanying drawings below:

FIG. 1 is a flowchart of an exemplary method for extending a layout template of a component according to embodiments of the present application;

FIG. 2a is a diagram of exemplary extension configuration information according to embodiments of the present application;

FIG. 2b is a diagram of exemplary extension configuration information according to embodiments of the present application;

FIG. 3 is a diagram of an exemplary layout template object of an existing component according to embodiments of the present application;

FIG. 4 is a flowchart of an exemplary method for extending a layout template of a component according to embodiments of the present application;

FIG. 5 is a flowchart of an exemplary method for extending a layout template of a component according to embodiments of the present application;

FIG. 6a is a diagram of an exemplary layout template object of a component to be extended according to embodiments of the present application;

FIG. 6b is a diagram of an exemplary layout template object of a component to-be-extended according to embodiments of the present application; and

FIG. 7 is a diagram of an exemplary device for extending a layout template of a component according to embodiments of the present application.

### DETAILED DESCRIPTION

Embodiments of the present application are described in detail below, examples of which are illustrated in the accompany drawings, where identical or similar reference signs refer to identical or similar elements or elements having identical or similar functions throughout. The embodiments described below with reference to the accompany drawings are only exemplary and are intended to explain the present application, and shall not be understood as a limit to the present application.

A method and a device for extending a layout template of a component according to the embodiments of the present application are described below with reference to the accompany drawings.

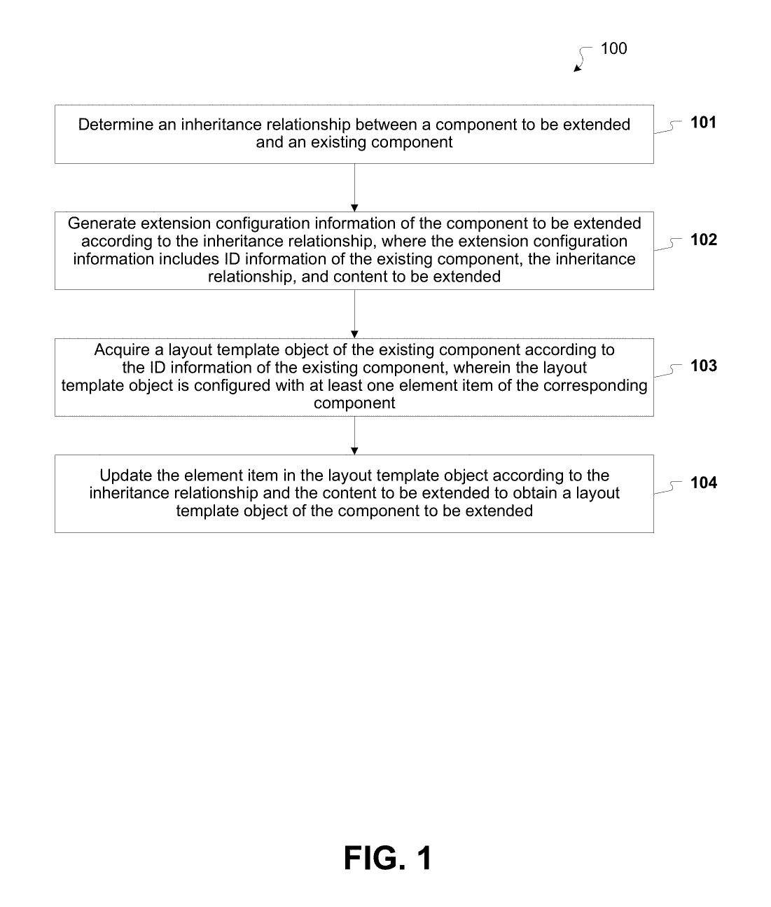

FIG. 1 is a flowchart of an exemplary method 100 for extending a layout template of a component according to an embodiment of the present application.

At step 101, an inheritance relationship between a component to be extended and an existing component is determined.

In some cases, services of a client may need to be updated, for example, when a new service type is added, or when a service state is added or changed. For example, in an online shopping scenario, services may include a plurality of service types such as a basic service, an international service, and a group buying service. Each service may have different service states. For example, the group buying service may have a first state when the group buying has started, and a second state when the group buying has not started.

Different service types and service states may have different layout displays, where the is service types and corresponding service states each correspond to different layout templates. Therefore, a layout template of a component of a client may need to be extended. The layout template may include content such as a page-layout file of a client component, data binding logic, and/or a page event, and may be implemented using a JavaScript Object Notation (JSON) format, for example.

When extending a template of a component, the extension may be performed according to an inheritance relationship among components. The inheritance relationship between components may include an extending relationship or an overriding relationship, for example. The extending relationship indicates that a new component inherits all the attributes of an original component, and a new attribute is added to the new component based on the original component. The overriding relationship indicates that a new component redefines/overwrites one or more attributes of an original component, and inherits other attributes of the original component.

At step 102, generate extension configuration information for the component to be extended according to the inheritance relationship, where the extension configuration information comprises identification (ID) information of the existing component, an inheritance relationship, and the content to be extended.

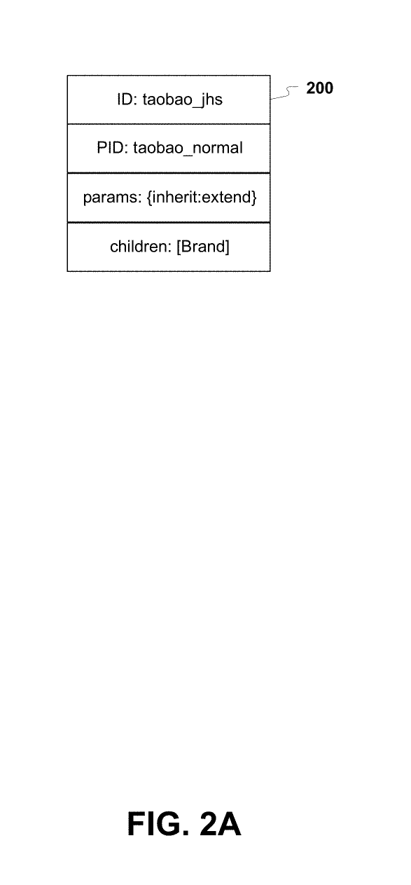

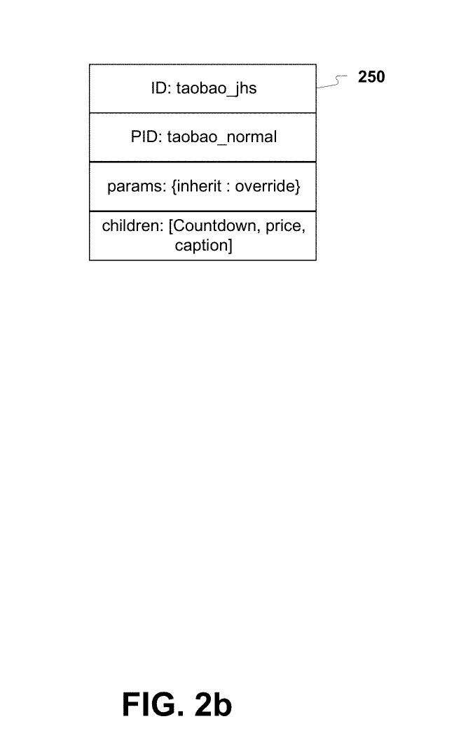

FIG. 2a is a diagram of exemplary extension configuration information according to embodiments of the present application. The extension configuration information 200 includes ID information of an existing component (PID: taobao_normal), ID information of a component to be extended (ID: taobao_jhs), an inheritance relationship (inheritance: extend), and content to be extended (children: [Brand]). Based on the extension configuration information 200 shown in FIG 2a, the component to be extended “taobao_jhs” refers to adding a sub-component “brand” to a sub-component list by inheriting all the attributes of the original component taobao_normal to extend the existing component.

FIG. 2b is a diagram of exemplary extension configuration information 250 according to embodiments of the present application. As shown in FIG. 2b, the extension configuration information 250 includes ID information of an existing component (PID: taobao_normal), ID information of a component to be extended (ID: taobao_jhs), an inheritance relationship (inheritance: override), and content to be extended (children: [countdown, price, caption]). On the basis of the extension configuration information 250 shown in FIG. 2b, the component to be extended taobao jhs_refers to redefining a sub-component list of the original component taobao_normal as [countdown, price, caption], and inheriting other attributes in the original component taobao_normal.

At step 103, acquire a layout template object of the existing component according to the ID information of the existing component, where the layout template object uses at least one element item of the corresponding component.

A generated layout template object may be stored and reused. When a corresponding component needs to be extended using a layout template object that has been generated, a corresponding layout template object may be identified from layout template objects that have been stored according to ID information of the component.

The at least one element item includes at least one basic attribute item and a sub-component list item. The sub-component list item is used to define a sub-component included in a component. A basic attribute item is used to define an attribute of a component, and may include an attribute keyword and an attribute value. For example, an attribute defined by a basic attribute item may include ID information of a component, ID information of a parent component, a component type, an attribute parameter, a sub-component list, a component event, and the like. Exemplary attribute keywords of element items and description of attribute values thereof are described in table 1.

TABLE 1

| Definition of | |
|---|---|
| attribute | |
| keywords | Description of attribute values |
| ID | uniquely identifies a component |
| PID | ID of a parent component |
| type | the type of component (e.g., a client component, |
| | a WeApp component, an H5 component, and a |
| | React-Native component) |
| key | a keyword of a component, which uniquely |
| | corresponds to a UI implementation class and |
| | View Model of a component |
| params | an attribute parameter of a component |
| children | a sub-component list |
| actions | a component event |

An “ID” attribute may be used to uniquely identify a layout template object, and may be unique within the layout and system. A “PID” attribute indicates an identifier of a layout template object of a parent component. If a template of a component is configured with a PID, there is an inheritance relationship between the template of the component and the layout template object identified by the PID. A “Type” attribute identifies the type of a component, for example, the component may be a client component, or may be a dynamic component provided by a third party. The type of a component may be used to determine a mapping rule for mapping the component to a client. “Key” is used to identify a UI implementation class and View Model for associating a layout template object with a client. “Params” describes an attribute parameter of a layout template object, and a style and display data of a component may be customized using params. “Children” is a sub-component list of a layout template object. A component having a sub-component list is referred to as a container component, and the container component may be used to determine a layout of a sub-component in the container. “Actions” indicates that a layout template object describes an event action of a component, and can be dynamically associated with an event of a component. A basic element of an action is similar to a basic attribute item used to define an attribute of a component.

According to some embodiments of the present invention, if a layout template object is configured with a PID, the PID used is unique. In other words, one layout template object may only inherit from one layout template object, and may not simultaneously inherit from a plurality of layout template objects, such that a sequential inheritance relationship may exist among layout template objects. An example of a valid inheritance sequence is: A→B→C→D→E, and an invalid inheritance sequence is

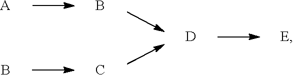

where A→B indicates that a layout template object B inherits from a layout template object A.

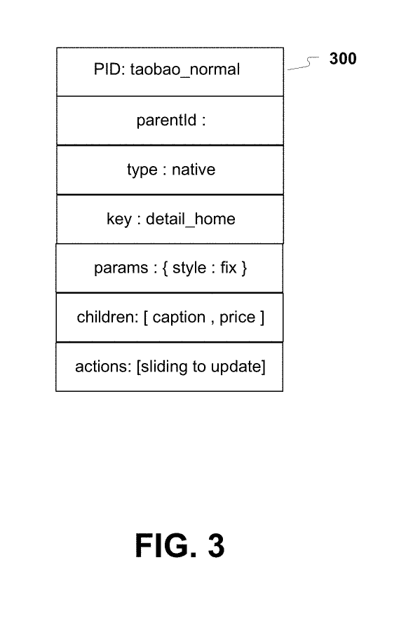

For example, FIG. 3 is a diagram of an exemplary layout template object 300 of an existing component according to embodiments of the present application. As shown in FIG. 3, the layout template object defines that ID information of a parent component of the component (with ID information being taobao_normal) is null, the component type is native, the keyword of the component is detail_home, the attribute parameter is {style: fix} (representing an initial default value), the sub-component list includes two children components, “caption” and “price”, and a component event is “sliding to update”.

The attribute parameter params in Table 1 may include an inheritance parameter used to define an inheritance relationship between a component and a parent component. The attribute parameter params may further include a parameter “before” or “after” used to determine a position relationship between children components. Parameters defined by params and descriptions of parameter keyword values may be illustrated as in Table 2. For example, with regard to a current component “image banner advertisement”, a keyword of an attribute parameter thereof is “before price”, which indicates that the component “image banner advertisement” is located before the component “price”. The usage of the parameter “after” is similar to that of “before”, and may be used to indicate that one component is located after another component.

TABLE 2

| Definitions of | |
|---|---|
| attribute | |
| parameters | Description of keyword values |
| inheritance | Inheritance indicates an inheritance relationship of |
| | a component, including an extending relationship or |
| | an overriding relationship. |
| before | Before indicates that a current component is before |
| | a component identified by ID. If a current component |
| | is configured to be after a plurality of components, |
| | the layout of components is sequentially performed |
| | according to a configuration sequence. |
| after | After indicates that a current component is after a |
| | component identified by ID. If a current component is |
| | configured to be after a plurality of components, the |
| | layout of components is sequentially performed |
| | according to a configuration sequence. |

At step 104, update the element item in the layout template object according to the inheritance relationship and the content to be extended to obtain a layout template object of the component to be extended.

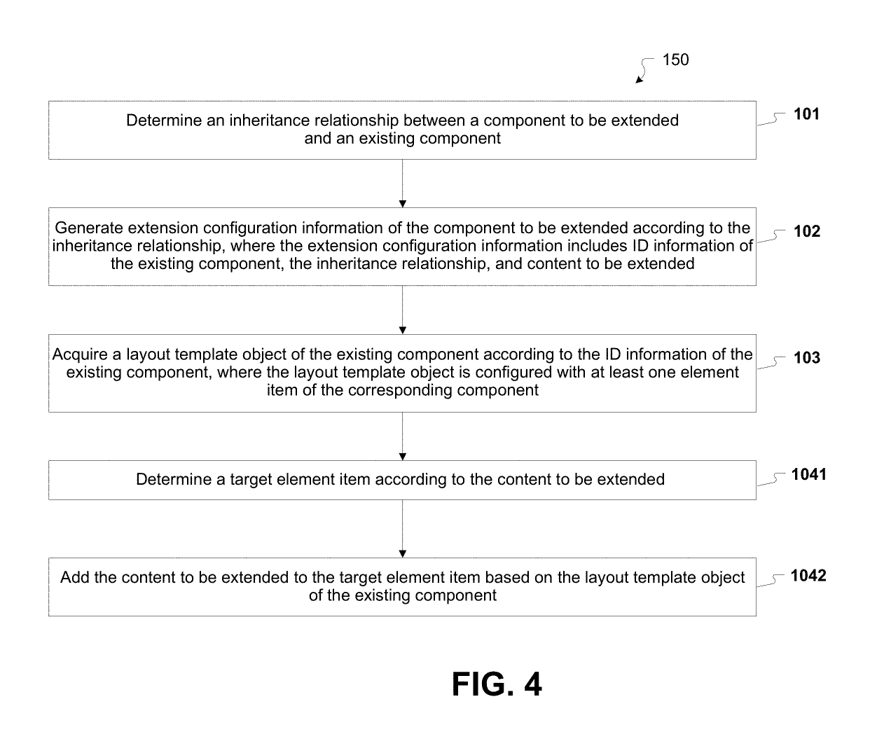

As shown in in FIG. 4, according to some embodiments, if the inheritance relationship is an extending relationship, step 104 includes:

At step 1041, determine a target element item based on the content to be extended.

At step 1042, add the content to be extended to the target element item based on the layout template object of the existing component.

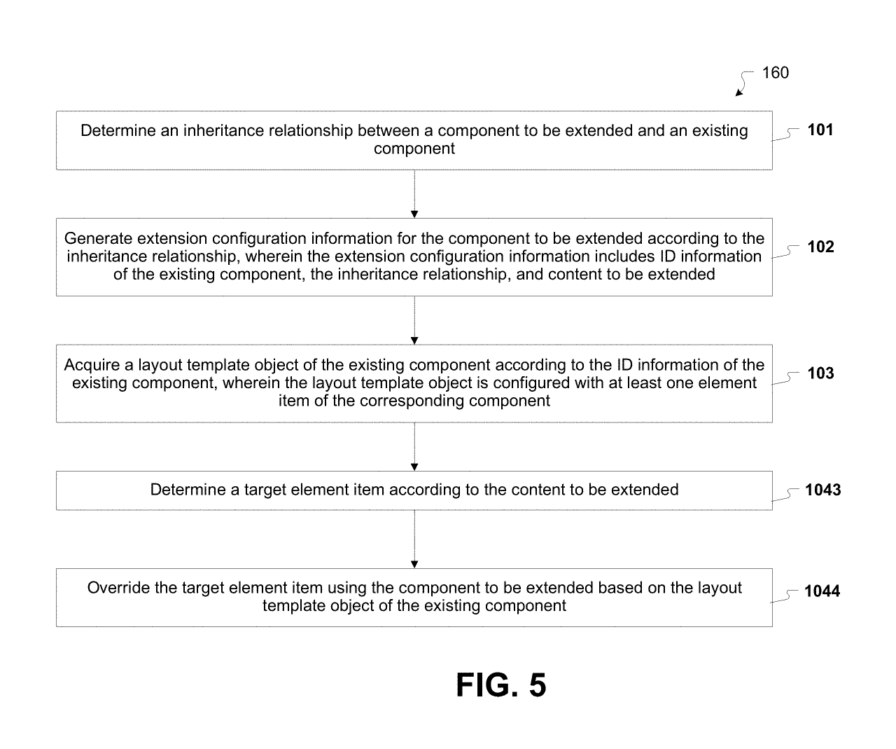

As shown in FIG. 5, according to some embodiments, when the inheritance relationship is an overriding relationship that may override existing values, step 104 includes:

At step 1043, determine a target element item according to the content to be extended.

At step 1044, override the target element item using the content to be extended, based on the layout template object of the existing component.

The content to be extended includes an element item corresponding to the extended content, and therefore, this element item in the layout template object of the existing component may be used as a target element item. Then, according to the inheritance relationship, content of the target element item may be added or overridden by using the content to be extended.

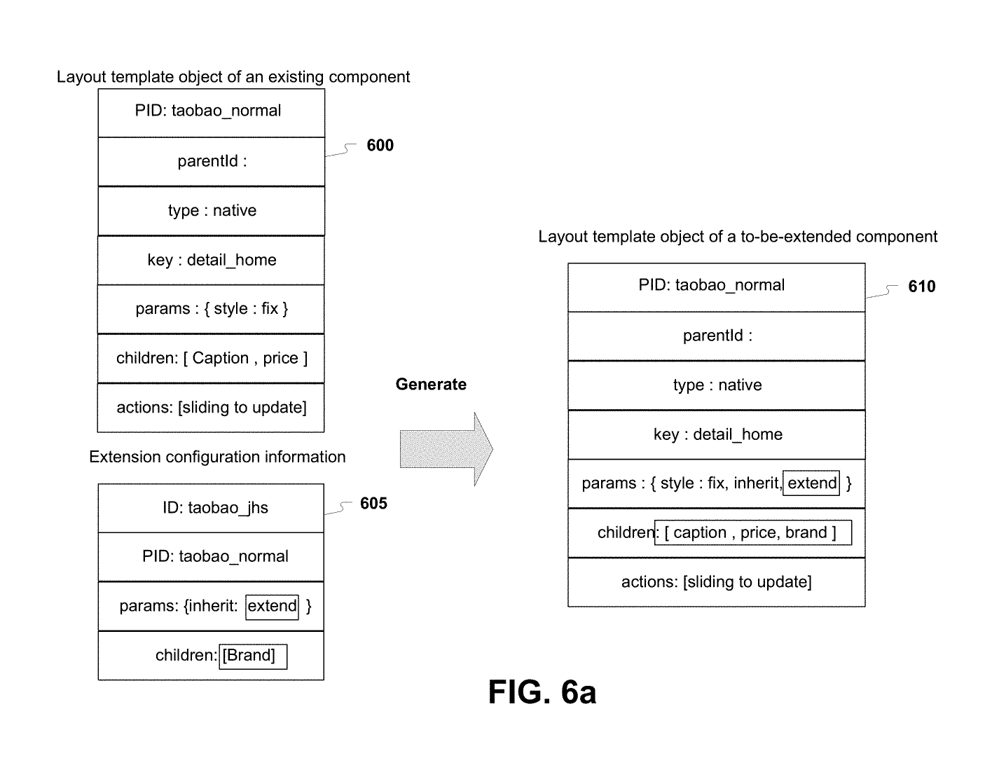

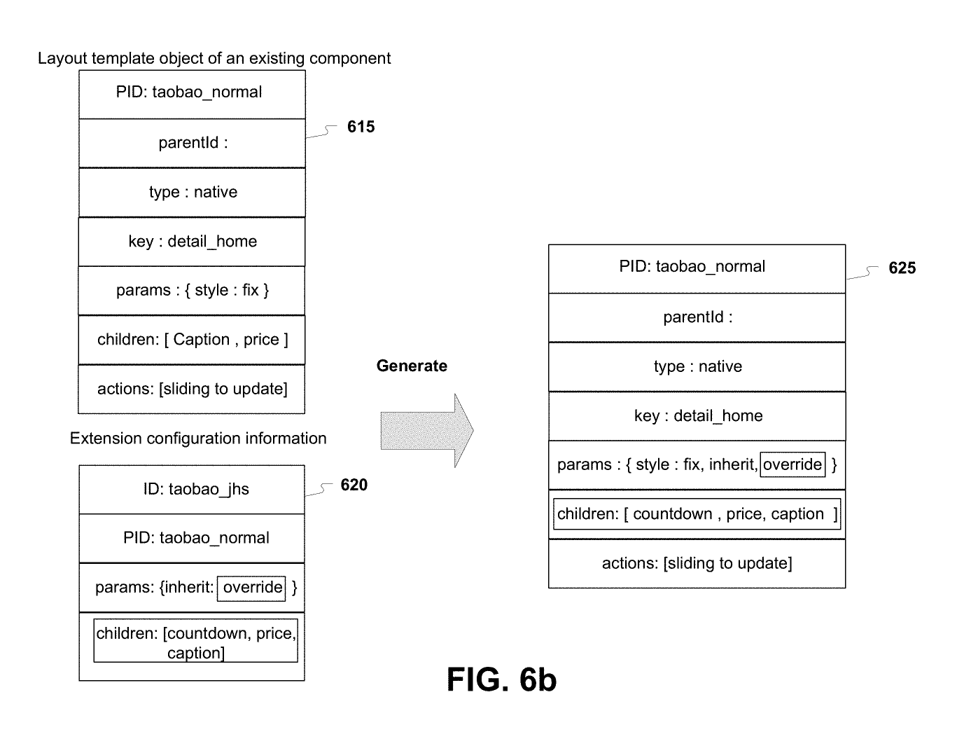

For example, FIG. 6a is a diagram of an exemplary layout template object of a component to be extended according to embodiments of the present application. The layout template object 610 of a component to be extended shown is generated according to the layout template object 600 of an existing component shown in FIG. 3, and the extension configuration information 605 shown in FIG. 2a. As shown in FIG. 6a, it can be determined from the extension configuration information 605 that the content to be extended is a sub-component list (children: [brand]), and the inheritance relationship is an extending relationship (inheritance: extend). Therefore, a sub-component [brand] may be added to the layout template object of the existing component, and the inheritance relationship “inheritance: extend” is added to the attribute parameter to obtain a layout template object of the component to be extended.

FIG. 6b is a diagram of an exemplary layout template object of a component to be extended according to embodiments of the present application. The layout template object of a component to be extended 625 shown in FIG. 6b is generated according to the layout template object of an existing component 615, and the extension configuration information 620. It can be determined from the extension configuration information that the content to be extended is a sub-component list (children: [countdown, price, caption]), and the inheritance relationship is an overriding relationship (inheritance: override). Therefore, children: [caption, price] in the layout template object of an existing component may be overridden as children: [countdown, price, caption], and the inheritance relationship, inheritance: override, is added to the attribute parameter, so as to obtain a layout template object of the component to be extended.

According to some embodiments of the present invention, a basic attribute item may further include a keyword used to determine a position relative to other children components, (e.g., before or after another component). Therefore, when the content to be extended is a new sub-component, the configuration information further includes a keyword used to determine a position relationship between a new sub-component and an existing sub-component. The method further includes determining a position of the new sub-component in a sub-component list item based on a keyword used to determine a position relationship between a new sub-component and an existing sub-component, and adding the new sub-component to the corresponding position in the sub-component list item according to the determined position.

For example, when content to be extended is a new component [image banner advertisement], where the corresponding ID is “image_banner”, and a keyword of an attribute parameter thereof included in configuration information is “before [price]” (e.g., before: normal_price), it can be determined that the new component [image banner advertisement] is located before an existing sub-component [price] in a sub-component list. Therefore, with regard to the layout template object shown in FIG. 3, in the newly generated layout template object, the sub-component list is overwritten to children [caption, image banner advertisement, price].

Extension configuration information of a component to be extended is generated according to an inheritance relationship between the component to be extended and an existing component. An element item in a layout template object of the existing component is updated according to the extension configuration information to obtain a layout template object for the component to be extended. In the present application, a reference to an object may be applied to the extension of a layout template of a component, and therefore, layout templates of different components may be associated by referencing the object, and new objects may be formed. Therefore, each layout template may be verified separately to improve an error rate of a layout template. Additionally, a layout template may be configured using an inheritance relationship between objects regardless of the complexity of the layout template to simplify the management of the layout template and the complexity of maintenance and updates.

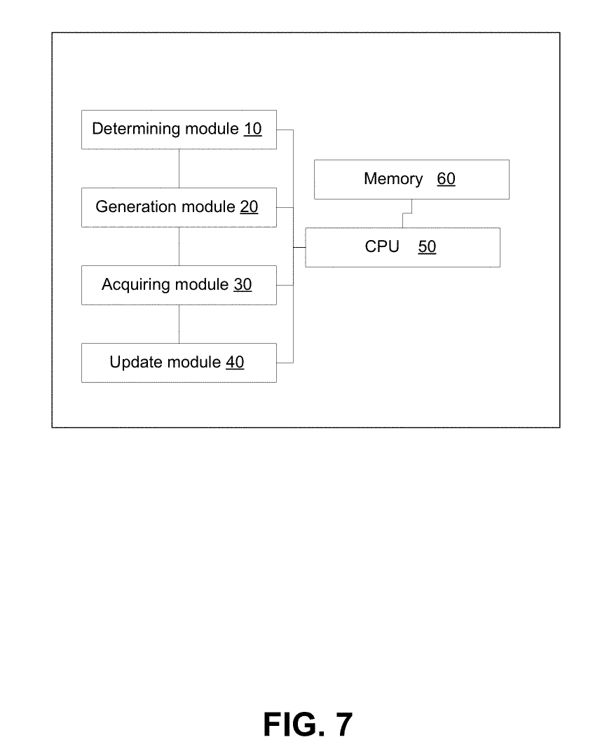

FIG. 7 is a diagram of an exemplary device for extending a layout template of a component according to embodiments of the present application. The device includes a determining module 10, a generation module 20, an acquiring module 30, an update module 40, a CPU 50, and a memory 60. CPU 50 is communicatively coupled to the determining module 10, generation module 20, acquiring module 30, and update module 40 for processing data, and uses memory 60 for storing data. The modules may be configured as separate hardware components, or configured as components of CPU 50. Memory 60 may be used to store components and layout objects, for example.

Specifically, the determining module 10 is configured to determine an inheritance relationship between a component to be extended and an existing component.

Services of a client may need to be updated, for example, when a service type is added, or when a service state is added or changed. For example, in an ecommerce scenario, services used may include a plurality of service types such as a basic service, an international service, and a group buying service. Each service may further have different service states. For example, the group buying service may have a state that group buying has started and a state that group buying has not started.

Different service types and service states may have different layout displays. In other words, service types and corresponding service states may correspond to different layout templates. Therefore, in some cases, a layout template of a component of a client may need to be extended. The layout template includes content such as a page-layout file of a client component, data binding logic, and/or a page event, and may be implemented using a format of a JavaScript Object Notation (JSON) file, a lightweight data interchange format.

When extending a template of a component, the extension may be performed according to an inheritance relationship between components. The inheritance relationship between components may include an extending relationship or an overriding relationship. An extending relationship means that a new component inherits the attributes of an original component, and a new attribute is added to the new component based on the original component. An overriding relationship means that a new component redefines one or more attributes of an original component, and inherits other attributes of the original component.

The generation module 20 is configured to generate extension configuration information of the component to be extended according to the inheritance relationship, where the extension configuration information includes ID information of the existing component, the inheritance relationship, and the content to be extended.

For example, as shown in FIG. 2a, the extension configuration information includes ID information of an existing component (PID: taobao_normal), ID information of a component to be extended (ID: taobao_jhs), an inheritance relationship (inheritance: extend), and content to be extended (children: brand). On the basis of the extension configuration information shown in FIG. 2a, the component to be extended taobao_jhs indicates that a sub-component “brand” is to be added to a sub-component list because the attributes of the original component taobao_normal are inherited.

As shown in FIG. 2b, the extension configuration information includes ID information of an existing component (PID: taobao_normal), ID information of a component to be extended (ID: taobao_jhs), an inheritance relationship (inheritance: override), and content to be extended (children: [countdown, price, caption]). Based on the extension configuration information shown in FIG. 2b, the component to be extended taobao_jhs redefines a sub-component list of the original component taobao_normal as [countdown, price, caption], and inherits other attributes in the original component taobao_normal.

The acquiring module 30 is configured to acquire a layout template object of the existing component according to the existing component's ID information, where the layout template object is configured with at least one element item of the corresponding component.

According to some embodiments of the present application, a generated layout template object may be stored. When a corresponding component needs to be extended according to a generated layout template object, the acquiring module 30 may find a corresponding layout template object according to the component's ID information.

An element item may include at least one basic attribute item and a sub-component list item. The sub-component list item is used to define a sub-component included in a component. Each basic attribute item is used to define one attribute of a component, including an attribute keyword and an attribute value. For example, an attribute defined by a basic attribute item may include ID information of a component, ID information of a parent component, a component type, an attribute parameter, a sub-component list, a component event, and the like. Attribute keywords of element items and description of attribute values thereof may be illustrated as in Table 1.

“ID” may be used to uniquely identify a layout template object. The ID is a unique identifier of the layout template object within the layout system. “PID” indicates an identifier of a layout template object of a parent component. If a template of a component is configured with a PID, it indicates that there is an inheritance relationship between the template of the component and another layout template object identified by the PID. “Type” identifies the type of a component, for example, the component may be a client component, or a dynamic component provided by a third party. The type of a component determines a mapping rule for mapping the component to a client. “Key” is used to identify a UI implementation class and a View Model for associated a layout template object with a client for implementation. “Params” is a description of an attribute parameter of a layout template object, and a style and display data of a component may be defined using params. “Children” is a sub-component list of a layout template object. A component including a sub-component list is a container component, and the container component determines a layout manner of a sub-component in the container. “Actions” indicates that a layout template object describes an event action of a component, and may be dynamically associated with an event of a component.

When a layout template object is configured with a PID, the PID should be unique. That is, one layout template object may only inherit from one layout template object and may not simultaneously inheritance from a plurality of layout template objects, and a sequential inheritance relationship may exist among layout template objects.

As shown in FIG. 3, the layout template object indicates that ID information of a parent component related to a component with ID information being taobao normal is null, the component type is native, the keyword of the component is detail_home, the initial value of the attribute parameter is {style: flx}, the sub-component list includes two children components, caption and price, and a component event is “sliding to update”.

The attribute parameter “params” in table 1 may include an inheritance parameter used to define an inheritance relationship between a component and a parent component thereof. The attribute parameter params may further include a parameter “before” or “after” used to determine a position relationship between children components. Parameters defined by params and description of parameter keyword values may be illustrated as in table 2. For example, with regard to a current component “image banner advertisement”, a keyword of an attribute parameter thereof is “before price”, which indicates that the component “image banner advertisement” is located before the component “price”.

The update module 40 is configured to update the element item in the layout template object according to the inheritance relationship and the content to be extended to obtain a layout template object for the component to be extended.

Specifically, if the inheritance relationship is an extending relationship, the update module 40 may be configured to determine a target element item according to the content to be extended and add the content to be extended to the target element item based on the layout template object of the existing component.

If the inheritance relationship is an overriding relationship, the update module 40 may determine a target element item according to the content to be extended and override the target element item, using the content to be extended, based on the layout template object of the existing component.

The content to be extended includes an element item corresponding to the extended content. This element item in the layout template object of the existing component may be used as a target element item. Then, according to the inheritance relationship, content of the target element item may be added to or overridden with the content to be extended.

FIG. 6a is a diagram of an exemplary layout template object of a component to be extended according to embodiments of the present application. The layout template object of a component to be extended shown in FIG. 6a is generated according to the layout template object of an existing component (see FIG. 3), and the extension configuration information shown in FIG. 2a. As shown in FIG. 6a, it can be determined from the extension configuration information that the content to be extended is a sub-component list (children: [brand]), and the inheritance relationship is an extending relationship (inheritance: extend). Therefore, a sub-component [brand] may be added to the layout template object of an existing component, and the inheritance relationship, inheritance: extend, is added to the attribute parameter to obtain a layout template object of the component to be extended.

FIG. 6b is a diagram of an exemplary layout template object of a component to be extended according to embodiments of the present application. The layout template object of a component to be extended is generated according to the layout template object of an existing component (see FIG. 3) and the extension configuration information (see FIG. 2b). It can be determined from the extension configuration information that the content to be extended is a sub-component list (children: [countdown, price, caption]), and the inheritance relationship is an overriding relationship (inheritance: override). Therefore, children [caption, price] in the layout template object of an existing component may be overwritten as children: [countdown, price, caption], and the inheritance relationship, inheritance: override, is added to the attribute parameter to obtain a layout template object of the component to be extended.

According to some embodiments of the present invention, a basic attribute item may include a keyword used to determine a position relationship between children components (e.g., before or after). Therefore, when content to be extended is a new sub-component, the configuration information includes a keyword used to determine a position relationship between a new sub-component and an existing sub-component. The update module 40 may be used to determine a position of the new sub-component in a sub-component list item according to a keyword, and add the new sub-component to the corresponding position in the sub-component list item according to the position indicated by the key word, where the keyword is used to determine a position relationship between a new sub-component and an existing sub-component.

For example, when content to be extended is a new component [image banner advertisement] (with corresponding ID image_banner), and a keyword of an attribute parameter thereof included in configuration information is “before [price]” (e.g., before: normal_price), it can be determined that the new component [image banner advertisement] is located before an existing sub-component [price] in a sub-component list. Therefore, in the newly generated layout template object, the sub-component list is changed to children [caption, image banner advertisement, price].

Extension configuration information of a component to be extended may be generated according to an inheritance relationship between the component to be extended and an existing component, and an element item in a layout template object of the existing component is updated according to the extension configuration information to obtain a layout template object of the component to be extended. In the present application, a reference to an object may be applied to the extension of a layout template of a component, and the layout templates of different components may be associated based on the object reference to form a new object. Therefore, each layout template may be verified separately to improve the error rate of a layout template. Additionally, when a layout template is configured, the layout template may be configured using an inheritance connection between objects regardless of the complexity of the layout template to effectively simplify the management of the layout template and the complexity of maintenance and updates.

The description of any process or method shown in the flowcharts or described in other manners herein may be understood as being indicative of including one or more modules, segments or parts for implementing the code of executable instructions for the steps of specific logic functions or processes, and that the scope of the preferred embodiments of the present application include other implementations, where the functions may be executed in manners different from those shown or discussed, including executing the functions according to the related functions in a substantially simultaneous manner or in a reverse order, which should be understood by persons skilled in the art to which the present application pertains.

The logic and/or steps shown in the flowcharts or described in other manners here may be, for example, understood as a sequencing list of executable instructions for realizing logic functions, which may be implemented in any computer readable medium, for use by an instruction executing system, device or devices (such as a system including a computer, a system including a processor, or other systems capable of extracting instructions from an instruction executing system, device, or device and executing the instructions), or for use in combination with the instruction executing system, device or device. With regard to the present specification, a “computer readable medium” may be any device, which may include, store, communicate, broadcast or transmit programs for use by an instruction executing system, device or device, or for use in combination with them. More specific examples of the computer readable medium (a non-exhaustive list) include the following: an electrical connection part (an electronic device) having one or more wirings, a portable computer disk box (a magnetic device), a random access memory (RAM), a read-only memory (ROM), an erasable and programmable read-only memory (an EPROM or a flash memory), an optical fiber device, and a portable CD read-only memory (CDROM). In addition, the computer readable medium may even be paper or other appropriate media upon which the program can be printed, because for example, paper or other media may be subjected to optical scanning, then processed by means of editing, interpreting or other appropriate means if necessary, to obtain the program in an electronic manner, and then the program can be stored in a computer memory.

It should be understood that various parts of the present invention may be implemented by means of hardware, software, firmware or a combination thereof. In the foregoing embodiments, a plurality of steps or methods may be implemented by means of software or firmware stored in a memory and executed by an appropriate instruction execution system. For example, when implemented by means of hardware in one embodiment, the steps or methods can be implemented by means of any one or a combination of the following techniques commonly known in the art: a discrete logical circuit having a logical gate circuit used for implementing a logical function on a data signal, a dedicated integrated circuit having an appropriate combinational logical gate circuit, a programmable gate array (PGA), a field programmable gate array (FPGA), and the like.

Persons of ordinary skill in the art may understand that all or some of the steps carried in the foregoing embodiment methods may be implemented by a program instructing relevant hardware. The program may be stored in a computer readable storage medium, and when being executed, the program includes one of the steps in the method embodiments or a combination thereof.

In addition, various functional units in the embodiments of the present invention may be integrated into one processing module, or each of the units may exist alone physically, or two or more units may be integrated into one module. The foregoing integrated module may be implemented in the form of hardware, or may be implemented in the form of a software functional module. When being implemented in the form of a software functional module and sold or used as an independent product, the integrated module may be stored in a computer readable storage medium.

The storage medium may be a read-only memory, a magnetic disk, or an optical disk, and the like.

In the present specification, the schematic expressions of the foregoing terms do not necessarily refer to the same embodiment or example. Furthermore, particular features, structures, materials or characteristics described may be combined in an appropriate manner in any one or more embodiments or examples.

Although the embodiments of the present application have been shown and described, it should be understood by persons of ordinary skill in the art that various changes, modifications, replacements and variations can be made to these embodiments without departing from the principle and spirit of the present application, and the scope of the present application is defined by the appended claims and equivalents thereof.

1. A method for updating a layout template of a component based on an inheritance relationship, the method comprising:
determining the inheritance relationship between the component and an existing component;
generating extension information for the component to be extended based on the inheritance relationship, wherein the extension information comprises identification information of the existing component, the inheritance relationship, and content to be extended;
acquiring a layout template object of the existing component based on the identification information of the existing component, wherein the layout template object is configured using at least one element item of a corresponding component; and
updating the element item in the layout template object to obtain a second layout template object for the component using the inheritance relationship and the content to be extended.

2. The method of claim 1, wherein the inheritance relationship comprises at least one of: an extending relationship and an overriding relationship.

3. The method of claim 2, wherein the inheritance relationship is an extending relationship, and the updating the element item in the layout template object to obtain a second layout template object for the component using the inheritance relationship and the content to be extended comprises:
determining a target element item according to the content to be extended; and
adding the content to be extended to the target element item using the layout template object of the existing component.

4. The method of claim 2, wherein the inheritance relationship is an overriding relationship, and the updating the element item in the layout template object to obtain a second layout template object for the component using the inheritance relationship and the content to be extended comprises:
determining a target element item according to the content to be extended; and
overwriting the target element item with the content to be extended using the layout template object of the existing component.

5. The method of claim 1, wherein the at least one element item comprises at least one basic attribute item and a sub-component list item.

6. The method of claim 5, wherein the basic attribute item comprises a keyword used to determine a position relationship among sub-components, and when the content to be extended is the sub-component list item, the configuration information further comprises a first keyword used to determine a position relationship between a new sub-component and an existing sub-component, and the method further comprises:
determining a position of the new sub-component in the sub-component list item according to the first keyword; and
adding the new sub-component to a position in the sub-component list item according to the position.

7. A device for updating a layout template of a component, comprising:
a determining module, configured to determine an inheritance relationship between a component and an existing component;
a generation module, configured to generate extension information of the component according to the inheritance relationship, wherein the extension information comprises identification information of the existing component, the inheritance relationship, and content to be extended;
an acquiring module, configured to acquire a layout template object of the existing component according to the identification information of the existing component, wherein the layout template object is configured with at least one element item of the corresponding component; and
an update module, configured to update the element item in the layout template object according to the inheritance relationship and the content to be extended to obtain a layout template object of the component.

8. The device of claim 7, wherein the inheritance relationship comprises at least one of an extending relationship and an overriding relationship.

9. The device of claim 8, wherein the inheritance relationship is an extending relationship, and the update module is configured to:
determine a target element item according to the content to be extended; and
add the content to be extended to the target element item on the basis of the layout template object of the existing component.

10. The device of claim 8, wherein the inheritance relationship is an overriding relationship, and the update module is then configured to:
determine a target element item according to the content to be extended; and
override the target element item based on the layout template object of the existing component using the content to be extended.

11. The device of claim 10, wherein the at least one element item comprises at least one basic attribute item and a sub-component list item.

12. The device of claim 11, wherein the basic attribute item comprises a keyword used to determine a position relationship among sub-components, the content to be extended is the sub-component list item, the configuration information further comprises a keyword used to determine a position relationship between a new sub-component and an existing sub-component, and the update module is further configured to:
determine a position of the new sub-component in the sub-component list item according to the keyword; and
add the new sub-component to the position in the sub-component list item.

13. The device of claim 10, wherein the component is displayed using the layout template object.

14. A device for updating a layout template of a component, comprising:
a memory; and
a processor communicatively coupled to the memory that determines an inheritance relationship between a component and an existing component stored in the memory, generates extension information for the component to be extended according to the inheritance relationship, wherein the extension information comprises identification information of the existing component, the inheritance relationship, and content to be extended, acquires a layout template object of the existing component according to the identification information of the existing component, wherein the layout template object is configured using at least one element item of the corresponding component, and updates the element item in the layout template object according to the inheritance relationship and the content to be extended to obtain a layout template object of the component.

15. The device of claim 14, wherein the inheritance relationship comprises at least one of an extending relationship and an overriding relationship.

16. The device of claim 15, wherein the inheritance relationship is an extending relationship, and the processor:
determines a target element item according to the content to be extended; and
adds the content to be extended to the target element item on the basis of the layout template object of the existing component.

17. The device of claim 15, wherein the inheritance relationship is an overriding relationship, and the processor:
determines a target element item according to the content to be extended; and
overrides the target element item on based on the layout template object of the existing component using the content to be extended.

18. The device of claim 17, wherein the at least one element item comprises at least one basic attribute item and a sub-component list item.

19. The device of claim 18, wherein the basic attribute item comprises a keyword used to determine a position relationship among sub-components, when the content to be extended is the sub-component list item, the configuration information further comprises a keyword used to determine a position relationship between a new sub-component and an existing sub-component, and the processor:
determines a position of the new sub-component in the sub-component list item according to the keyword used to determine the position relationship between the new sub-component and the existing sub-component; and
adds the new sub-component to a corresponding position in the sub-component list item according to the position.

20. The device of claim 14, wherein the component to be extended is displayed using the layout template object.
